(19) United States
(12) Patent Application Publication
(10) Pub. No.: US 2025/0023286 A1
(43) Pub. Date: Jan. 16, 2025

(54) A CONNECTION MODULE AND SYSTEM

(71) Applicant: Siemens Gamesa Renewable Energy A/S, Brande (DK)

(72) Inventors: Cagribey Esen, Risskov (DK); Brian Rasmussen, Give (DK)

(21) Appl. No.: 18/711,153

(22) PCT Filed: Nov. 29, 2022
(86) PCT No.: PCT/EP2022/083705

§ 371 Date: May 17, 2024

(30) Foreign Application Priority Data
Nov. 30, 2021 (EP) 21211317.9

(51) Int. Cl. H01R 13/514

(52) U.S. Cl. CPC H01R 13/514

(57) ABSTRACT

A power connection module is provided which includes a first and a second submodules, an intermediary submodule and a plurality of conductors arranged at the intermediary submodule. Each first and second submodules includes a plurality of internal and external connection points. The intermediary submodule is arranged between the first and second submodules and includes a central portion. The plurality of conductors are arranged at the intermediary submodule and are grouped in at least a first phase group and a second phase group, wherein the electric phase of the conductors in the first phase group being different from the electric phase of the conductors of the second phase group. In central portions of the intermediary submodule, the plurality of conductors form a predetermined matrix cross-section, which comprises rows and columns. The conductors arranged in adjacent rows and/or columns of such matrix cross-section belong to a different phase group.

### CROSS-REFERENCE TO RELATED APPLICATIONS

This application claims priority to PCT Application No. PCT/EP2022/083705, having a filing date of Nov. 29, 2022, which claims priority to EP application Ser. No. 21/211,317.9, having a filing date of Nov. 30, 2021, the entire contents both of which are hereby incorporated by reference.

### FIELD OF TECHNOLOGY

The following relates to a power component connection module.

### BACKGROUND

The power connection between main power components of a wind turbine, e.g., transformer, converter, generator, etc.; requires long heavy electric conductors i.e., cables or busbars, to be connected, i.e., bolted, at a first power component in a predetermined connection point; then transported by an operator to a second power component where the conductor is secured in a predetermined connection point. The assembling procedure is very time-consuming and complex, as it shall be repeated for a large number of conductors or conductor ends. Besides, the length of the conductors may be about 10 m long, or even more in some examples, which further complicates the assembling process.

In addition, misplacement of cables may lead to underperformance, overload of certain cables, an increase of uneven electromagnetic fields or even to a fire which may damage or destroy the wind turbine and/or cause serious injuries to operators.

### SUMMARY

An aspect relates to a solution which reduces the assembling time and complexity of power component connection while increasing the safety at reasonable cost.

In a first aspect, a power connection module is provided. The power connection module comprises a first and a second submodule, an intermediary submodule and a plurality of conductors arranged at the intermediary submodule. Each first and second submodules comprise a plurality of internal connection points and a plurality of external connection points. The intermediary submodule is arranged between the first and second submodules and comprises a central portion. The plurality of conductors are arranged at the intermediary submodule and are grouped in at least a first phase group and a second phase group, wherein the electric phase to be conducted by the conductors in the first phase group is different from the electric phase to be conducted by the conductors of the second phase group. In substantially all central portions of the intermediary submodule, the plurality of conductors forms a predetermined matrix cross-section, such predetermined matrix cross-section comprises rows and columns. The conductors arranged in adjacent rows and/or columns of such matrix cross-section belong to a different phase group.

By using a predetermined matrix cross-section avoids having same electric phase conductors in adjacent rows and/or columns thereby preventing electrical problems such as uneven current sharing in the intermediary submodule, and in addition the connection module is capable of using full capacity of the cables.

The use of separate (independent) submodules enhances the scalability of the connection module. By having an intermediary submodule enables adapting the length of the connection module to a specific situation, i.e., to the connection (distance) of two wind turbine components, without modifying the first and second submodules. That is, more than one intermediary submodule may be used to adapt to the distance between the two turbine components to be interconnected without requiring. Thus, due to the modularity of the connection module, the manufacturing costs may be kept low as the basic submodules (first, second and intermediary submodules) may adapt to achieve different connections e.g., to different components of a wind turbine or to the configuration of different wind turbine models.

Moreover, using different submodules enables the connection module to be a preassembled unit, therefore the complexity of a connection process between two power components such as a generator and a converter in a wind turbine may be reduced. A premade or preassembled unit may further reduce costs as its manufacturing process may be outsourced to a supplier.

By using a connection module as claimed, operators do not deal with a plurality of individual conductors but use a module which contributes to a better connection quality as the risk of misplacement is reduced.

In addition, the use of connection module as claimed reduces the time required in the connection process.

In an embodiment, the matrix cross-section may comprise a base pattern.

In an embodiment, the base pattern may be shifted by one row in adjacent columns of the matrix cross-section thereby further reducing the probability of having electric problems in conductors.

In an embodiment, the module may further comprise a housing which may be made of a conducting material or may be made of a non-conducting material and comprise a conducting mesh. By having a conducting element, Electromagnetic Compatibility (EMC) and grounding advantages may be provided.

In an embodiment, the module may further comprise an interconnection element configured to enable an angled connection between the plurality of conductors and a power component, which further facilitates the connection process and enhances the adaptability of the connection module.

In an embodiment, the interconnection element may comprise a plurality of coupling holes.

In a further aspect, a power connection system is provided. The power connection system may comprise at least two power connection modules according to any of the examples disclosed coupled therebetween. The flexibility and scalability of the system may be improved as any required number of modules may be coupled together.

In a further aspect, a wind turbine comprising a power connection module according to any of the examples disclosed is provided.

### BRIEF DESCRIPTION

Some of the embodiments will be described in detail, with references to the following Figures, wherein like designations denote like members, wherein:

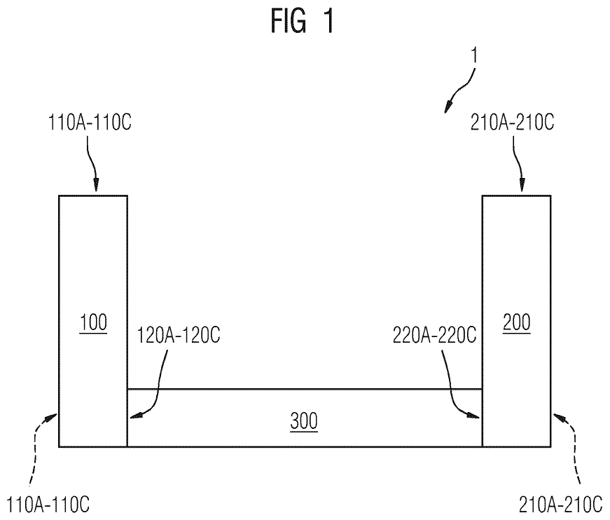

FIG. 1 schematically illustrates a power connection device according to an embodiment:

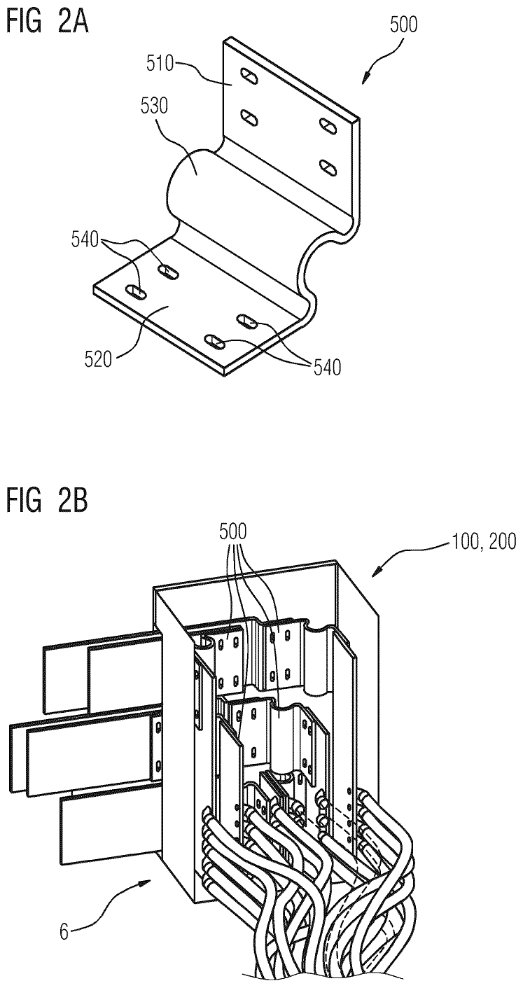

FIG. 2A schematically illustrates an interconnection element according to an embodiment:

FIG. 2B schematically illustrates part of a power connection module comprising a plurality of interconnection elements according to an embodiment:

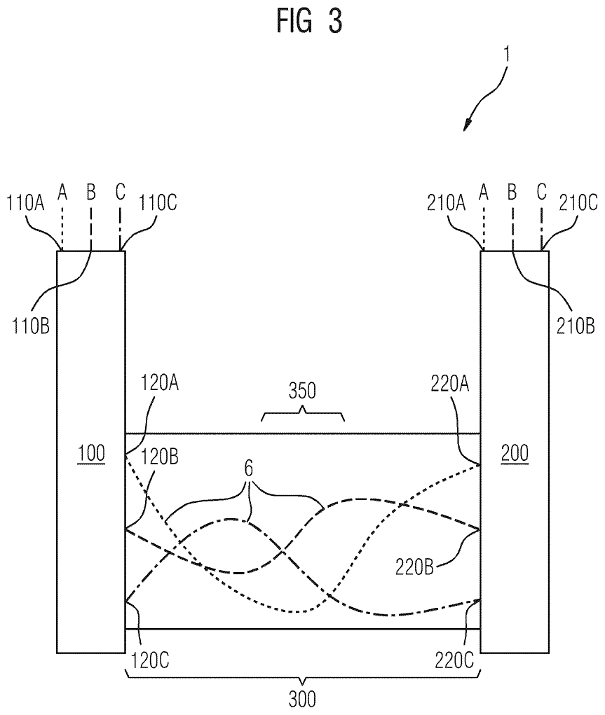

FIG. 3 schematically illustrates a power connection device according to an embodiment:

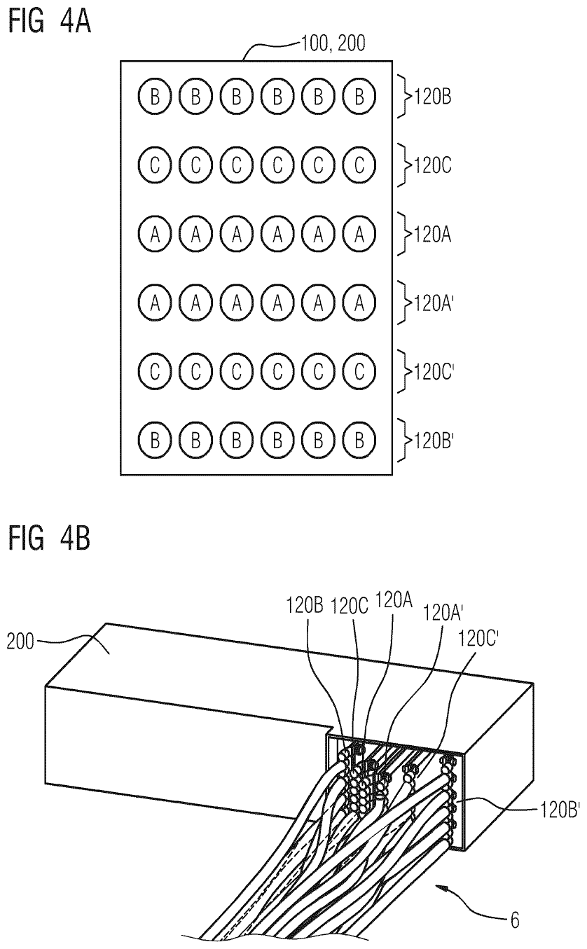

FIG. 4A schematically illustrates an internal connection point of a submodule according to an embodiment:

FIG. 4B schematically illustrates an internal connection point of a submodule according to an embodiment:

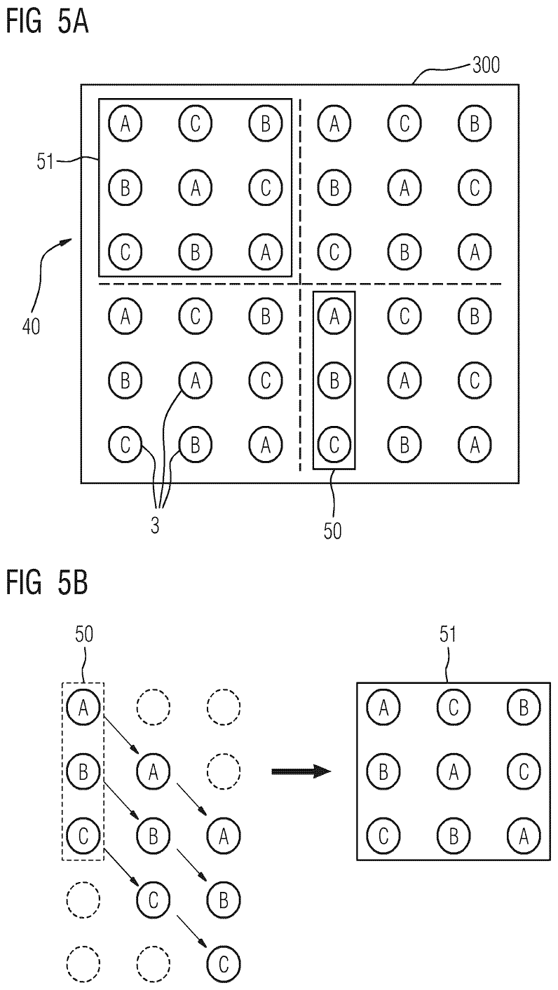

FIG. 5A schematically illustrates a conductor matrix pattern at an intermediary submodule according to an embodiment; and

FIG. 5B schematically illustrates a part of a basic pattern and a repetition pattern according to an embodiment.

### DETAILED DESCRIPTION

FIG. 1 depicts a power connection module 1 for electrically coupling together two power components e.g., a generator and a converter, of a wind turbine. The module 1 may comprise a first and second terminal submodules 100, 200 and an intermediary submodule 300 comprising a plurality of conductors 6 (see FIG. 3) arranged therein.

The first and second (terminal) submodules 100, 200 may comprise a plurality of internal connection points 120A-120C, 220A-220C and a plurality of external connection points 110A-110C, 210A-210C. The external connection points may be arranged at any point of the submodules 100, 200. In an embodiment, the internal connection points 120A-120C, 220A-220C and the external connection points 110A-110C, 210A-210C may form a straight connection. In an embodiment, the internal connection points 120A-120C, 220A-220C and the external connection points 110A-110C, 210A-210C may form an angled (e.g., 90 degree or any other angle) connection.

The connection points may comprise securing holes to enable coupling the conductors thereto e.g., by bolts or in any other suitable way.

The connection points may be arranged according to a predefined standard scheme for properly matching the connections of an external device e.g., another module or a power component such as a converter. In an embodiment, the plurality of connection points may be parallel and may gather according to a respective electric phase. That is, conductors sharing or configured to conduct or carry the same electric phase may be arranged in parallel (see FIG. 4A) i.e., adjacent to one another in the same row.

The internal and/or external connection scheme or arrangement may be equal or different in the first submodule 100 and in the second submodule 200.

The connection points may be individual orifices, e.g., male-female connector; or may also be busbars wherein a plurality of conductors of a same phase may be connected.

The first submodule 100 may be an elongated or L-shaped body which may comprise an angled connection between external connection points 110A-110C and internal connection points 120A-120C.

The second submodule 200 may be an elongated or L-shaped body that may comprise an angled connection between external connection points 210A-210C and internal connection points 220A-220C.

The connection module 1 or each first, second and intermediary submodules may further comprise a housing. The housing may be made of conducting material e.g., metal or metal alloy. In other examples, the housing may be made of non-conducting material, e.g., plastic, and may further comprise a conducting material mesh. In examples wherein each first, second and intermediary submodules comprise a housing, the housings may comprise coupling elements to assemble the submodules together.

The housing may comprise handles (not shown) to facilitate the transport of the connection module and the connection process, i.e., connection to external device such as the generator of a wind turbine.

The housing may comprise a plurality of holes (not shown) configured to match with the external connection points of first and second terminal submodules thereby enabling the connection between the power connection device and an external component, e.g., to a converter.

The connection module 1 may be a premade or preassembled unit which further reduces the complexity of the connection process and enable a cost reduction.

In some embodiments, the connection module 1 may further comprise an interconnection element 50 (at least one per phase) to enable an angled connection, i.e., different from straight or 0 degrees, between the module 1 and an external component e.g., a converter.

FIG. 2A depicts an interconnection element 500 according to an example.

The interconnection element 500 may comprise two sides 510, 520 coupled together by a joint 530. The two sides may form any required angle e.g., 45 degrees, 90 degrees, etc. In the example of FIG. 2A both sides are perpendicular thereby enabling a 90-degree connection angle.

Each side 510, 520 may comprise a plurality of coupling holes 540 for securing the interconnection element 500 to e.g., a busbar.

FIG. 2B shows a first or a second terminal submodule 100, 200 comprising six interconnection elements 500 (two per phase) which are coupled to an internal connection point e.g., an internal bus bar, and to an external connection point e.g., an external busbar. In the example, the interconnection elements 500 enable the external connection points or busbars to which e.g., a generator is connected, to form 90 degrees with respect to the conductors 6.

The interconnection element 500 may be made of metal or any other electric conductor material or alloy.

FIG. 3 further depicts the internal view of an intermediary submodule of the power connection module 1 of FIG. 1.

The plurality of conductors 6 within the intermediary section may have an end to be coupled to an internal connection point 120A-120C of the first submodule 100 and the other end to the internal connection point 220A-220C of the second submodule 200. The conductors may not be arranged straight, i.e., forming about 0 degrees between both ends. For sake of clarity, in FIG. 3 a three-phase A, B, C example is implemented, wherein a conductor for each (electric) phase is represented by a different dashed line, however, any number of conductors per phase may be used.

The intermediary submodule 300 may comprise a central portion 350 that may be about 20-60% of the total length of the intermediary submodule 300.

The plurality of conductors 6 may be configured to conduct a predefined (electric) phase and they may be grouped at least in a first phase group and a second phase group, wherein the phase to be conducted by the conductors in the first phase group being different from the phase of the conductors of the second phase group. The number of phase groups may be proportional to the number of phases. In case the device may be a three-phase device, the conductors may be grouped in a first, a second and a third phase groups.

For the sake of clarity and simplicity, in FIG. 3 three conductors 6 (with different dashed lines), i.e., one conductor per electric phase, are shown.

The length of the conductors 6, and thus, of the intermediary submodule 300 may vary e.g., according to the distance between the external power components or may have a prefixed length. In some embodiments, the length of the plurality of conductors may be about 10 m, 5 m or any other required length.

In embodiments, the connection module 1 may comprise two or more interconnected intermediary submodules to avoid manufacturing lengthy intermediary submodules. The connection module may therefore be more flexible as it may be easily adapted to specific cases.

The ends of the plurality of conductors 6 may be connected to the first and second submodules with same electric phase conductors in parallel following a standard scheme, i.e., rows wherein adjacent cables belong to same phase group. Besides, in order to avoid electrical problems such as current sharing the conductors may, at least in a cross-section of the central section 350 of the intermediary submodule 300, be arranged in a predetermined matrix form.

The predetermined matrix cross-section may comprise rows and columns. In such predetermined matrix cross-section 40, the conductors 6 may be arranged such that in adjacent rows and columns conductors with a different electric phase, i.e., belonging to a different phase group (see FIGS. 5A and 5B) are arranged.

In embodiments, the predetermined matrix cross-section may be continuous along entire or substantial part of the central portion 350 of the intermediary submodule. That is, the arrangement of the conductors may hold the position at least in part of the central portion 350. In other examples, the predetermined matrix cross-section may be repeated a plurality of times i.e., more than two times, at different parts, i.e., in different cross-sections, along the intermediary submodule 300. In those examples, the conductors may be twisted various times thereby forming the predetermined matrix cross-section two or more times along central portion 350 of the intermediary submodule. Thus, the conductors within the intermediary submodule may, in some portions or areas, be straight. Due to the separation or empty space existing between the conductors a cooling effect may be obtained. Besides, in other portions, i.e., the central portion, the conductors may be twisted to form the predetermined matrix cross-section to avoid or at least minimize uneven current sharing i.e., to maximize the current conducted by each conductor.

FIG. 4A schematically shows an (standard) arrangement of a plurality of internal connection points or busbars 120A-120C, 120A′-120C′ of a first and/or second submodule 100, 200 according to an example. In the figure, a three-phase submodule having twelve conductors per electric phase (arranged in two respective separate busbars) is shown. The conductors 6 in same row may have or may be configured to transmit the same phase.

FIG. 4B depicts a submodule 200 comprising a plurality of conductors 3 coupled to the inter connection points (busbars) 120A-120C, 120A′-120C′ according to the arrangement of FIG. 4A.

FIG. 5A depicts a matrix cross-section 40 in the central portion of an intermediary submodule 300 of a three-phase connection module comprising twelve conductors per electric phase. The matrix cross-section of the example of FIG. 5A comprises six rows and six columns wherein the conductors in adjacent rows and columns may have or may be configured to conduct different phases.

In an embodiment, the matrix cross-section may comprise a basic pattern 50 that may be repeated thereby forming a predetermined matrix cross-section 40. The basic pattern 50 may be a predetermined arrangement of conductors configured to avoid positioning conductors conduct the same phase in adjacent rows and/or columns.

The basic pattern 50 may shifted by one row in adjacent columns thereby creating a repetition pattern 51.

FIG. 5B depicts a shifting of a basic pattern 50 thereby creating a repetition pattern 51 in a three-phase example.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A power connection module for electrically coupling together two separate components, the power connection device comprising:
a first and a second submodules, each first and second submodules comprising a plurality of internal connection points and a plurality of external connection points;
an intermediary submodule arranged between the first and second submodules, the intermediary submodule comprising a central portion;
a plurality of conductors arranged at the intermediary submodule, wherein the plurality of conductors are grouped in at least a first phase group and a second phase group, wherein the electric phase to be conducted by the conductors in the first phase group is different from the current electric phase to be conducted by the conductors of the second phase group; and
wherein
at least in a cross-section of the intermediary submodule, the plurality of conductors form a predetermined matrix cross-section, the predetermined matrix cross-section comprising rows and columns, and wherein the conductors arranged in adjacent rows and/or columns of such matrix cross-section belong to a different phase group.

2. The power connection module according to claim 1, wherein matrix cross-section further comprising a base pattern.

3. The power connection module according to claim 2, wherein the base pattern is shifted by one row in adjacent columns of the matrix cross-section.

4. The power connection module according to claim 1, wherein the intermediary submodule comprises a housing.

5. The power connection module according to claim 4, wherein the housing is made of conducting material.

6. The power connection module according to claim 4, wherein the housing is made of non-conducting material and further comprising a conducting mesh.

7. The power connection module according to claim 1, further comprising an interconnection element configured to enable an angled connection between the plurality of conductors and an external power component.

8. The power connection module according to claim 7, wherein the interconnection element further comprising two sides coupled together through a joint.

9. The power connection module according to claim 7, wherein the interconnection element further comprising a plurality of coupling holes.

10. The power connection module according to claim 1, comprising two or more interconnection modules.

11. A wind turbine comprising a power connection module according to claim 1.
